(19) United States
(12) Patent Application Publication
(10) Pub. No.: US 2008/0000289 A1
(43) Pub. Date: Jan. 3, 2008

(54) Seal Member for Use With Leakage Testing Apparatus, Seal Ring for Use With Leakage Testing Apparatus, and Seal Jig for Use With Leakage Testing Apparatus

(75) Inventor: Akio Furuse, Tokyo (JP)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Cosmo Instruments Co., Ltd., Tokyo (JP)

(21) Appl. No.: 10/589,786

(22) PCT Filed: Feb. 20, 2004
(86) PCT No.: PCT/JP04/01976

§ 371 Date: Aug. 16, 2006

(51) Int. Cl. F16J 15/10

(52) U.S. Cl. 73/46

(57) ABSTRACT

A seal ring having rounded-corner rectangular shape in cross-section is mounted in a recessed groove formed in ring configuration in a pressure-contact surface of a seal jig such that major axis of the seal ring is oriented perpendicular to the pressure-contact surface and the seal ring is projected out the pressure-contact surface by about 15-35% of length of the major axis to be compressively deformable in the direction of the major axis, and stoppers formed of low thermal conductivity resin are disposed on the pressure-contact surface, the peripheral portion of the opening of an article being tested is brought into pressure-contact with the seal ring in a manner such that the stoppers are interposed therebetween and that the compressively deformed seal ring provides an adequate sealing effect to seal the opening, whereby testing may be conducted without bringing the article being tested into contact with the seal jig.

### FIELD OF THE INVENTION

This invention relates to a seal member for a leakage testing apparatus to be used for testing the presence or absence of gas or liquid leakage (which will be simply referred to as “leakage” or “leak” hereinafter) in hermetically sealed articles such as various containers, engine blocks, gas appliances and the like in which there should be no leakage, and to a seal jig for use with a leakage testing apparatus utilizing such seal member.

### PRIOR ART

The leakage testing apparatus for testing the presence or absence of leakage in hermetically sealed containers, utilizing air pressure pressurized or depressurized is equipped with a seal jig. With the opening of an article being tested pressed against the seal jig, a compressed air is applied to the article being tested through the seal jig (in the case of pressure testing), or the air is drawn out of the interior of the article being tested (in the case of reduced-pressure testing). While the interior of the article being tested is maintained at an air pressure higher than or lower than the atmospheric pressure, whether there is any leakage or not is judged by determining whether the air pressure is maintained for a predetermined period of time.

For this reason, the seal member used to hermetically couple the seal jig to an article being tested is an important component, so that the sealing performance of the seal member greatly influences the performance of the leakage testing apparatus.

For the seal member used with the leakage testing apparatus, two types of seal members are employed depending on the difference in the manufacturing method. One of them is to use a seal member which is configured by being punched out of an elastic sheet such as rubber sheet into an annular shape surrounding the opening of an article being tested, and the other one is to use as a seal member an annulus ring (which is commonly called O-ring) made of an elastic material having a circular cross-section.

The seal member configured by being punched out of an elastic sheet into the shape of the opening of an article being tested is expensive since it must be manufactured by measuring the dimensions for each of different shapes of the openings of the various articles being tested. Therefore, this type of seal member is utilized only when the seal testing cannot be carried out with an O-ring.

In contrast, the O-ring, which is commercially available in various sizes with different diameters, is sold at low prices and are widely utilized as seal members for use with leakage testing apparatus.

The O-ring is generally made of elastic material having a JISA hardness of 60˜90 degrees such as nitrile rubber, urethane rubber, silicone rubber, fluorocarbon rubber or the like. In use, the O-ring is fitted by more than half thereof into an annular recessed groove formed in the pressure-contact surface of a seal jig with the remainder thereof projecting from the pressure-contact surface of the seal jig. The peripheral portion of the opening of an article being tested is then pressed against the projecting portion of the seal member so that the projecting portion is entirely forced into the recessed groove and thus the seal member is used with the article being tested 10 sealed in contact with the seal jig 20. If the article being tested 10 were not in contact with the seal jig 20, the article being tested 10 would not be stabilized in position, so that the amount of compressive deformation of the O-ring 24 would vary and hence the internal volume of the article being tested would vary by a corresponding amount, resulting in the occurrence of seal noise.

An example of the prior art seal jig utilizing an O-ring made of nitrile rubber will be described below.

FIGS. 10A and 10B show how the seal jig is used. In the drawings, 10 is an article being tested and 20 is a seal jig mounted on a leakage testing apparatus. Connected to the seal jig 20 is a piping 21 which in turn leads to the leakage testing apparatus, not shown, the arrangement being such that the article being tested 10 is pressurized with compressed air or evacuated of the air through the piping 21. The seal jig is formed in its pressure-contact surface 22 with an annular recessed groove 23 surrounding the portion of connection with the piping 21. An O-ring 24 is fitted in this recessed groove 23 to form a part of the seal jig 20. While the recessed groove 23 formed in the pressure-contact surface 22 of the seal jig 20 is a groove square in cross-section or generally square but tapered so as to flare to some extent in the direction of its depth, it is described herein as a simple square groove.

Generally, the O-ring 24 is circular in cross-section, and in the case of the conventional leakage testing apparatus, the recessed groove 23 is configured such that the groove width W in its cross-section is approximately equal to the diameter d of the O-ring. The height T of that portion of the O-ring 24 projecting out of the recessed groove 23 corresponds to a maximum allowance for squeeze because the projecting portion is to be entirely squeezed into die groove as stated hereinabove, and is chosen to be a height enough for a necessary and sufficient sealing effect to be obtained by a compressive force applied for compressing the projecting portion and yet such a height that the entire volume of the compressed O-ring is accommodated in the groove, which is around 10˜20% of the diameter d of the cross-section of the O-ring 24.

In this regard, if one determines the relationship between a thrust (squeezing force per unit height=N/mm) required to insert and compress an O-ring of 3.5 mm in cross-sectional diameter into a recessed groove having a groove width approximately equal to the ring diameter d (which state is called restrainedly inserted state) and the rate of compression (rate of compression=(height prior to compression−height after compression)/diameter prior to compression), the curve C and curve D will be obtained as shown in FIG. 8 wherein the curve C and curve D represent the measured values for nitrile rubber having a JISA hardness of 60 degrees and 70 degrees, respectively.

For information, the aforesaid relationship determined in the case where the O-ring by itself is in its free state instead of being in the restrainedly inserted state is also shown in FIG. 8 wherein the curve A and curve B represent the O-rings of nitrile rubber having a JISA hardness of 60 degrees and 70 degrees, respectively.

From these data, it will be seen that assuming that the thrust required for sealing is 2˜10N/mm, the rate of compression required of the O-ring of the curve C is higher than 15˜20% (greater than 0.5˜0.7 mm for the allowance for squeeze) while the rate of compression required of the O-ring of the curve D is 8˜20% (0.3˜0.7 mm for the allowance for squeeze).

For these reasons, the height of that portion of the O-ring projecting out of the recessed groove 23 is chosen to be around 10˜20% of the diameter d of the cross-section of the O-ring 24 as indicated above, and hence the depth D of the recessed groove 23 should be about 80˜90% of the cross-sectional diameter d.

The depth D and groove width W of the recessed groove 23 are sized such that when the O-ring 24 is compressively deformed as shown in FIG. 10B by pressing the peripheral edge of the opening of an article being tested 10 against the projecting portion of the O-ring 24 until the projecting portion is entirely squeezed into the recessed groove, the compressed air (in the case of pressure testing) will not be allowed to leak out of the groove, or, the outside air will not be allowed to leak into the evacuated chamber (in the case of reduced-pressure testing). Incidentally, an illustration showing the means for pressing the seal jig 20 against the article being tested 10 is omitted.

However, it has been found that in the prior art testing apparatus, since the leakage test is conducted with the article being tested 10 in contact with the seal jig 20, heat transfer would take place between the article being tested and the seal jig in contact with each other if there is a temperature differential between the two, which would cause a temperature change (which will be called temperature drift) on the article being tested, resulting in deterioration in the leakage testing performance.

The present applicant has heretofore illuminated the cause of occurrence of such temperature drift, and has proposed a number of methods for eliminating the influences caused by the temperature drift or making an appropriate compensation therefor and apparatus for carrying out such methods.

For example, the present applicant pointed out in Japanese Patent Application No. 2000-206431 (Japanese Patent Application Laid Open No. 2002-22592) and Japanese Patent Application No. 2001-259370 (Japanese Patent Application Laid Open No. 2003-106923) that the source of a drift which may occur during the test origins from the fact that the article being tested 10 and the seal jig 20 in contact with each other.

More specifically, it has been ascertained that due to the article being tested 10 and the seal jig 20 being in contact, thermal energy transfer between the article being tested 10 and the seal jig 20 is free to take place, whereby the temperature of the air in the interior of the article being tested 10 may fluctuate, which may in turn produce a phenomenon of causing a pressure variation as if there were a leak in spite of the fact that actually there is no leak.

But, the patent applications earlier proposed have not gone beyond proposing the drift correcting method of compensating for a drift.

Specifically, in order to provide for such drift compensation, it is required that at least a temperature sensor for measuring the temperature of the article being tested 10 and a temperature sensor for measuring the temperature of the seal jig 20 be used to carry out the calibration mode in which the amounts of drift compensation corresponding to amounts of the temperature differentials are determined and memorized. Consequently, there is a disadvantage in that much time and effort are required to conduct the calibration for determining the amounts of drift compensation. And there is still another disadvantage in that a computing unit for determining the amounts of drift compensation and others (including programs for realizing it on a computer) are also required, resulting in a complicated and expensive leakage testing apparatus.

As a method for eliminating the influences of drift, it is one of conceivable ideas that first, the seal jig itself be constructed of a material having a low thermal conductivity, but as the use of a metal material may be imperative because of requirements of mechanical durability and others, it would not be a radical solution.

In view of the foregoing, the present inventor took to heart the need for development of a testing apparatus which does not require that the article being tested 10 be brought into contact with the seal jig 20 and yet which does not produce seal noises.

To that end, the inventor has thought of the concept of adopting a structure providing for accomplishing the coupling between the seal jig and the article being tested by compressive deformation of a seal member and further preventing the amount of compressive deformation of the seal member from fluctuating by interposing a spacer (which will be referred to as stopper hereinafter) formed of a material having a low thermal conductivity between the seal jig and the article being tested.

In this regard, for the stopper for realizing such structure, a thickness of at least more or less about 0.5 mm is required so as to provide a strength enough to withstand breakage during the pressing operation, and desirably the thickness should be in the order of at most about 1.0 mm or less. Further, the stopper may be in the form of an annular disc, but desirably comprises a plurality of segmented parts, and is configured so as not to abut the entire article being tested 10. In addition, a material having a low thermal conductivity such as acetal resin or polyamide resin or the like, for example may be used.

In adopting such structure, however, in the case where the easiest-to-use ring having a cross-sectional diameter of 3.5 mm as shown in FIG. 10A is used as an O-ring 24, if the depth D of the recessed groove 23 is sized at 2.8 mm which is 80% of the diameter of 3.5 mm, the projecting amount T of the O-ring 24 projecting beyond the pressure-contact surface of the seal jig 20 will by about 0.7 mm (see FIG. 1A). It should be here noted that this O-ring 24 is required to have an amount of compressive deformation (allowance for squeeze) of about 0.5˜0.7 mm in order to provide an adequate sealing effect, but the projecting amount would be insufficient and after all, it would not be possible to use O-rings having a cross-sectional diameter of 3.5 mm.

In an attempt to realize a structure utilizing the O-ring and yet having the stopper, theoretically that might be possible if an O-ring considerably larger than 3.5 mm, say larger than 5 mm in cross-sectional diameter were employed, but such ring would be absolutely unsuitable for practical and universal use since the ease of use is extremely limited.

From the foregoing it has been found out nearly impossible to realize the technical consent of the present invention using the O-ring.

### DISCLOSURE OF THE INVENTION

An object of this invention is to provide a seal jig for use with a leakage testing apparatus which allows for conducting a leakage test without bringing an article being tested and the seal jig bringing into direct contact and yet minimizing the occurrence of seal noise, a seal ring to be used with the seal jig which seal ring is capable of freely making its ring diameter, and a seal member used as a seal ring.

The seal member for a leakage testing apparatus according to this invention is a rod-like body (which will be also referred to as string-like body hereinafter as it is a rod-like body of an elastic material) formed of an elastic material which is of a rectangular shape in cross-section having a major axis extending in a direction in which a compressive force is exerted and a minor axis extending perpendicularly to the major axis and shorter than the major axis, major sides equal to the length L_{A} of the major axis and minor sides equal to the length L_{B} of the minor axis with the edges at four corners arcuately removed therefrom (which will be called rounded-corner rectangle hereinafter).

The seal ring for a leakage testing apparatus according to the present invention is a ring-like structure which is formed by cutting such seal member in the form of a string-like body into a desired length and joining together the opposite cut ends such that the major axis is oriented in the direction in which a compressive force is exerted.

The seal jig for a leakage testing apparatus according to the present invention includes a plurality of stoppers attached to the pressure-contact surface thereof opposing an opening of an article being tested, the stoppers being formed of a low thermal conductivity material and having a thickness corresponding to a desired gap, and a ring-shaped recessed groove of a square shape in cross-section having a groove width approximately equal to the minor axis of the seal member, the arrangement being such that the aforesaid seal ring is inserted into the recessed groove in such attitude that the direction of the major axis of the cross-section aligns with the direction of insertion into the recessed groove (that is, the direction in which a compressive force is exerted), namely, into a restrainedly inserted state, and such that the ring projects beyond the groove by a projecting amount equal to the height of the stoppers plus a height enough to insure a desired amount of compressive deformation.

Accordingly, by bringing this seal jig into pressure contact with an article being tested, the seal ring is compressively deformed in the direction of the major axis until the article being tested comes into abutment against the stoppers, and the seal ring seals the opening of the article being tested with an adequate sealing effect with the amount of compressive deformation made until the article being tested comes into abutment against the stoppers.

### BRIEF DESCRIPTION OF THE DRAWINGS

FIG. 1A is a cross-sectional view showing the cross-sectional shape of a first example of the seal member for a leakage testing apparatus according to this invention;

FIG. 1B is a cross-sectional view showing a second example;

FIG. 2 is a perspective view for illustrating the seal member for a leakage testing apparatus according to this invention;

FIG. 3A is a plan view showing a strip cut from the seal member for a leakage testing apparatus according to this invention;

FIG. 3B is a plan view showing the seal ring for a leakage testing apparatus according to this invention as obtained by bonding the opposite ends of the seal member;

FIG. 4 is a cross-sectional view of a mold for molding the seal member shown in FIG. 2;

FIG. 5 is a perspective view seen from the bottom for illustrating a jig for cutting the seal member shown in FIG. 2;

FIG. 6A is a plan view of a cutting apparatus including the cutting jig shown in FIG. 5;

FIG. 6B is a side view of the cutting apparatus;

FIG. 7A is a plan view of a connecting jig for bonding the opposite ends of the seal member shown in FIG. 3A;

FIG. 7B is a front view of the connecting jig shown in FIG. 7A;

FIG. 8 is a graph showing the relationship between the compressive deformation rate of the seal rings according to the present invention having different lengths of the minor axis and the compressive forces required to accomplishing it, and also showing the data concerning the conventional O-rings for comparison;

FIG. 9A is a cross-sectional view of a seal jig for a leakage testing apparatus utilizing the seal ring according to this invention;

FIG. 9B is a cross-sectional view illustrating how the seal jig for a leakage testing apparatus utilizing the seal ring according to this invention is practically used (after the pressure-contact);

FIG. 10A is a cross-sectional view of a seal jig for a leakage testing apparatus utilizing a conventional O-ring; and

FIG. 10B is a cross-sectional view illustrating how the seal jig is practically used (after the pressure-contact).

### BEST MODES FOR CARRYING OUT THE INVENTION

The present invention will be described in details with reference to the accompanying drawings. In the drawings, like parts are indicated by like reference numerals.

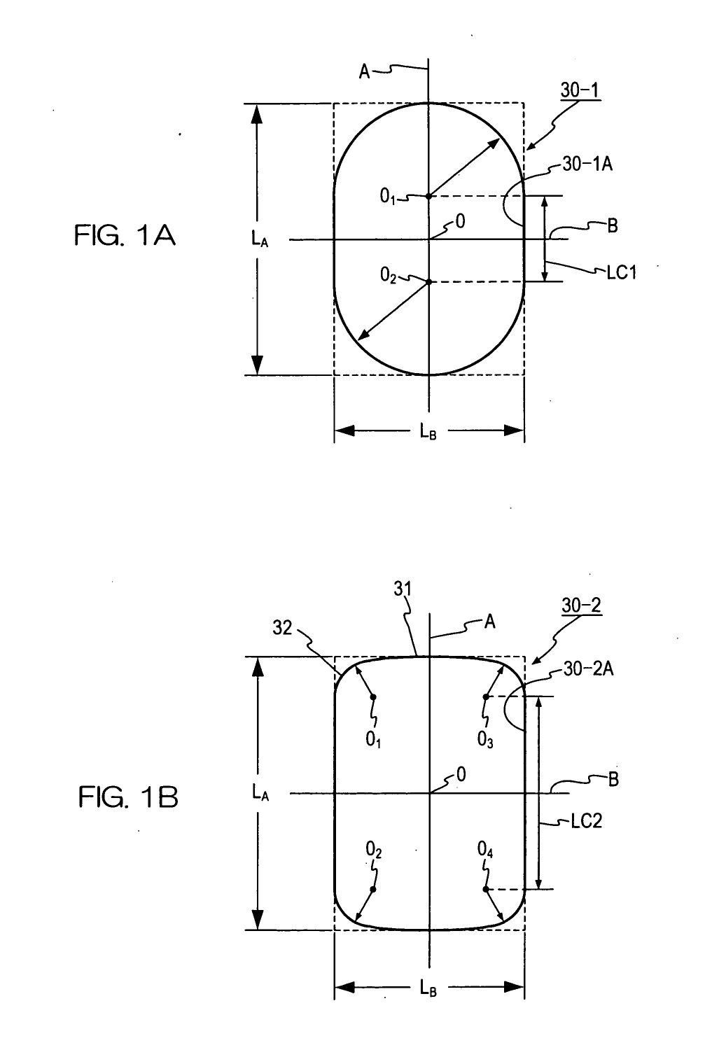

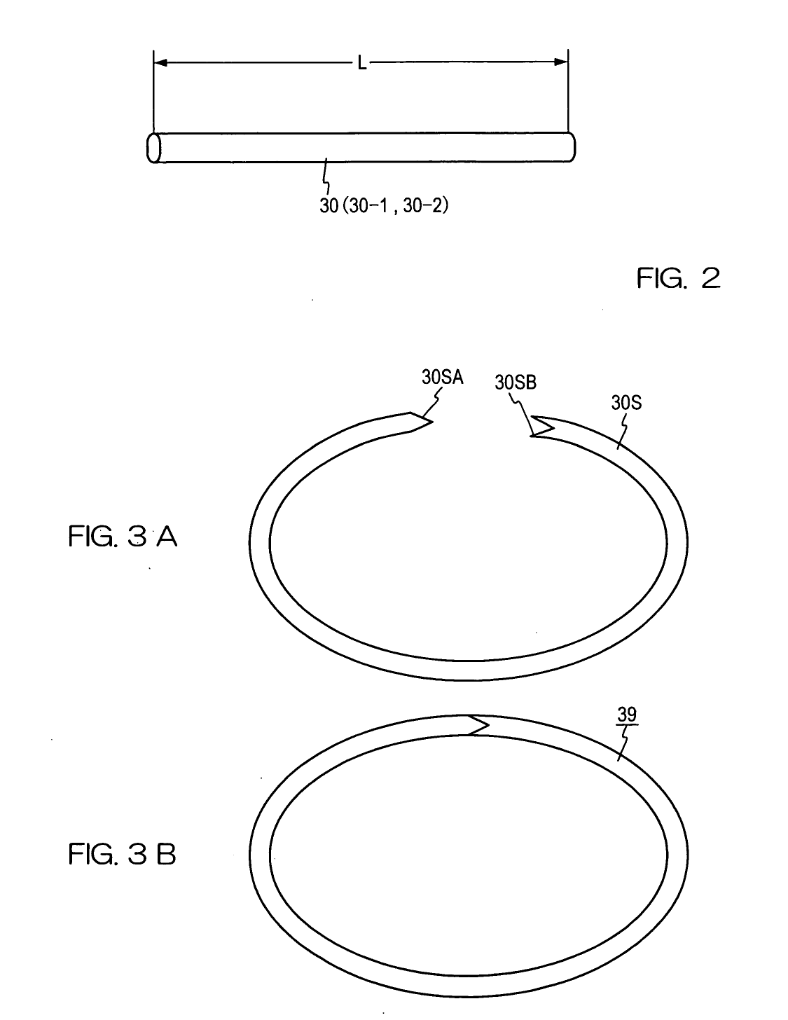

FIG. 1A shows a cross-section of a first embodiment 30-1 of the seal member 30 for a leakage testing apparatus according to this invention. The seal member 30-1 of this first embodiment is molded from a rubber-based elastic material in a cavity utilizing a mold 33, 34, and is obtained in the form of a string-like body having an appropriate length L. say about 3 m.

This seal member 30-1 represents an instance in which it is configured, as a cross-sectional form, into a shape of “rounded-corner rectangle” comprising an imaginary rectangle (shown in phantom lines) having a major axis A and a minor axis B orthogonal to the major axis, the dimension L_{A}=5 mm measured in the direction of the major axis being major sides and the dimension L_{B}=3.5 mm measured in the direction of the minor axis being minor sides with each corner edge removed therefrom in the form of an arc with a radius of curvature of L_{A}/3 (corresponding to L_{B}/2). In FIG. 1A, O is a point of intersection of the major axis A and the minor axis B, O1 and O2 being a center of the radius of curvature of the arcuately removed portions at the corners. The central portions of the minor sides of this rounded-corner rectangle are arcuate in shape while the midsections of the major sides have a band-like portion 30-1A extending over the length L_{C1}=L_{A}/3 in the direction of the major axis.

FIG. 1B shows a cross-section of a second embodiment 30-2 of the seal member for a leakage testing apparatus according to this invention. This seal member 30-2 represents an instance in which it is configured, as a cross-sectional form, into a shape of “rounded-corner rectangle” comprising an imaginary rectangle (shown in phantom lines) having a major axis A and a minor axis B, the dimension L_{A}=5 mm measured in the direction of the major axis being major sides and the dimension L_{B}=3.5 mm measured in the direction of the minor axis being minor sides, with the central portions of the minor sides being made as larger arcuate portions 31 and with each corner edge removed therefrom in the form of an arc with a radius of curvature of L_{A}/6 (corresponding to L_{B}/4) so as to form smaller arcuate portions 32. In FIG. 1B, O is a point of intersection of the major axis A and the minor axis B, O1˜O4 being a center of the radius of curvature of the arcuately removed portions at the corners. The central portions of the minor sides of fibs rounded-corner rectangle are of an arcuate shape with a large radius of curvature while the midsections of the major sides have a band-like portion 30-2A extending over the length L_{C2}=2L_{A}/3 in the direction of the major axis.

For the material of the seal member 30 of this invention, elastic materials used to form conventional O-rings are likewise usable. By way of example, elastic materials such as nitrile rubber (general-purpose sealing material), urethane rubber (high-strength and wear-resistant sealing material) and the like may be used. And from the viewpoint of ease of use, the structure should be such that the length of the minor axis be 3˜4 mm and that the length L_{A} of the major axis be in the range not exceeding two times, desirably 1.2˜1.5 times the length L_{B} of the minor axis.

In addition, regarding the cross-sectional shape of the seal member of this invention, while it may be a rectangle itself having major sides equal to the length L_{A} of the major axis and minor sides equal to the length L_{B} of the minor axis, for the convenience of molding process it may be a “rounded-corner rectangle” having the edges at four corner removed in the form of an arc indicated in dotted lines, as shown in FIG. 1A or FIG. 1B. In this regard, while the shape as shown in FIG. 1A or FIG. 1B is given as an example of the rounded-corner rectangular cross-sectional shape of the seal member of this invention, it may be varied in shapes other than those indicated above, as required.

Conventionally, O-rings are prepared in several different cross-sectional diameters. In Addition, although there are prepared rings in a plurality of sizes having different across-the-ring diameters for each one of the cross-sectional diameters, all of them may not conform with the peripheral shape of the openings of articles being tested.

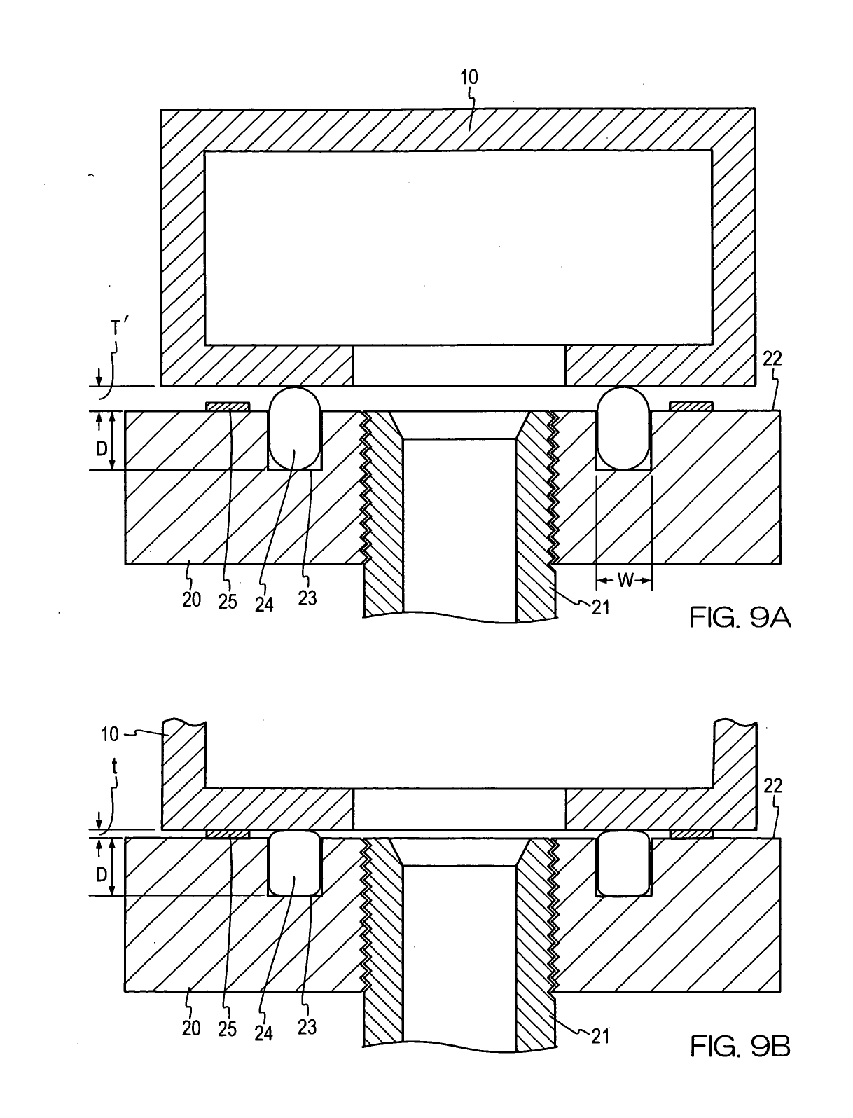

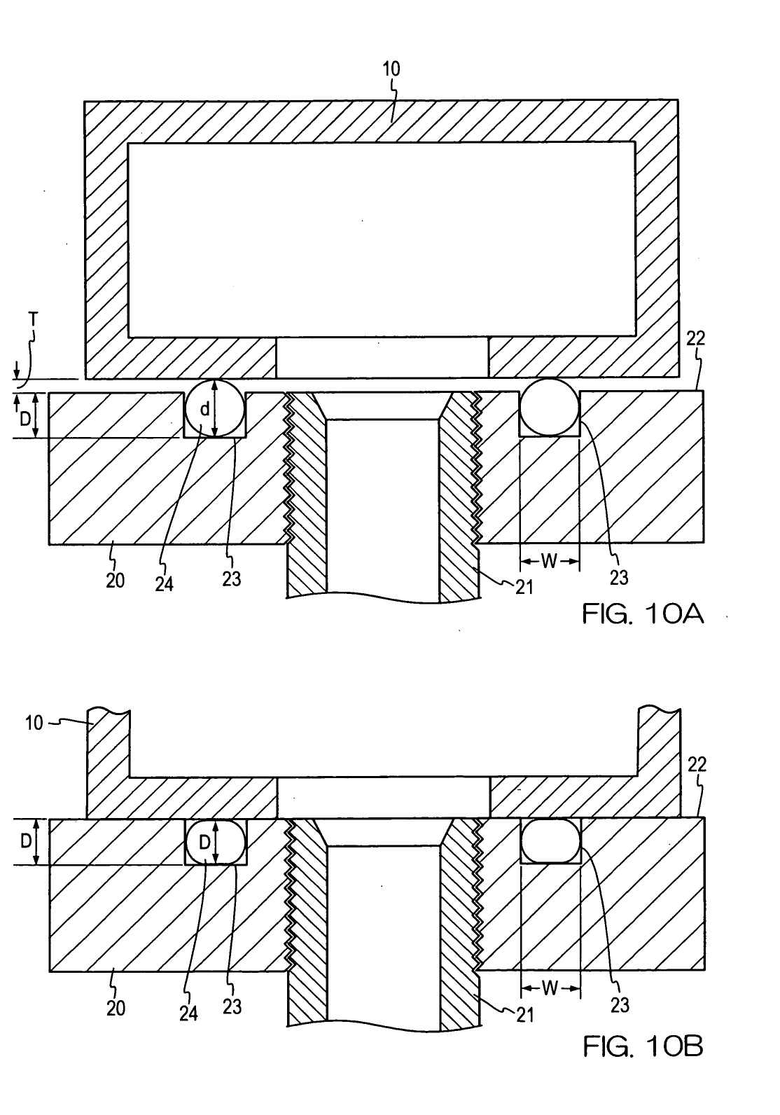

The seal ring of the present invention overcomes the drawbacks to the O-ring described above. Specifically, a ring-shaped recessed groove 23 is formed in the pressure-contact surface of die seal jig 20 of the present invention shown in FIG. 9A so as to correspond with the diameter of the opening required to be sealed of an article being tested 10 and surround the outside of the opening. Then, a seal member strip 30S is cut in a size equal to the perimeter of the recessed groove 23 from the string-like seal member 30 (30-1, 30-2) of elastic material according to the present invention, followed by bonding the opposite ends of the seal member strip 30S together to obtain a seal ring of die present invention.

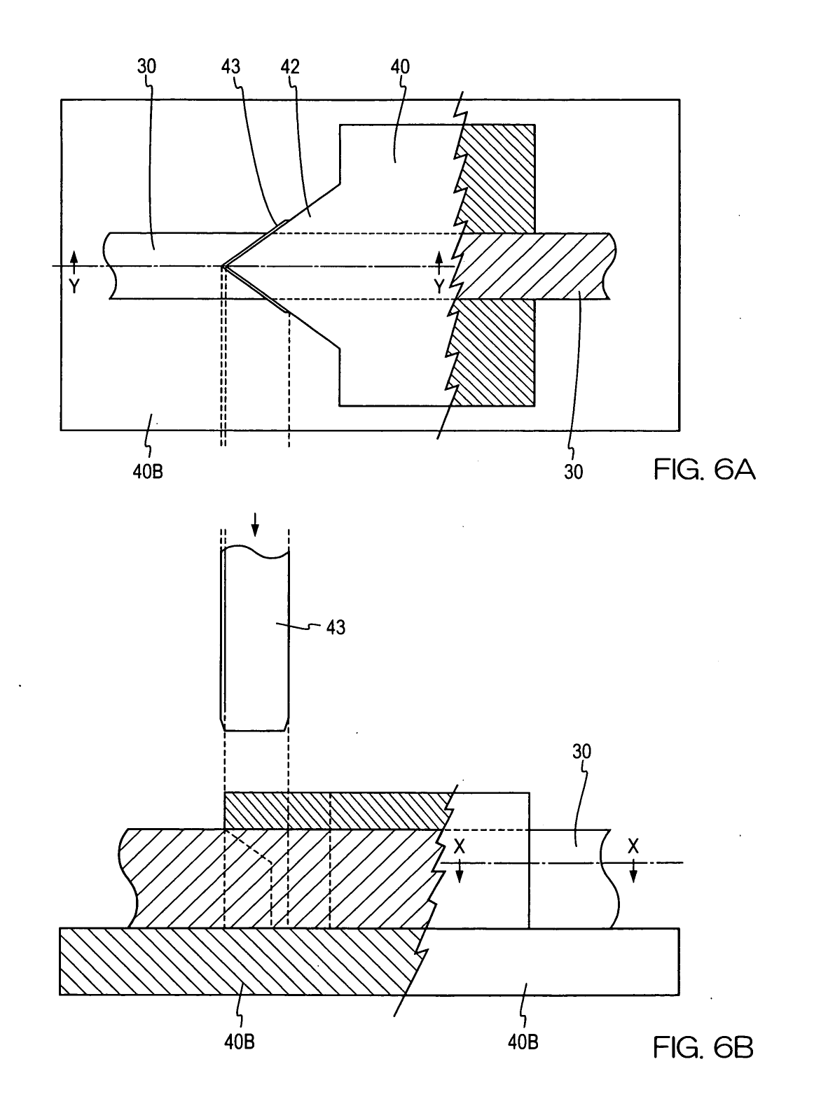

FIG. 5 and FIGS. 6A and 6B illustrate the structure of a cutting jig 40 to cut the seal member 30-1, 30-2 in a V-shaped cross-section. FIG. 5. is a perspective view of the cutting jig 40 seen from the bottom side and FIG. 6A is a plan view of the cutting apparatus (including a partly cut-away cross-sectional view taken along X-X). FIG. 6B shows a side view of the cutting apparatus (including a partly cut-away cross-sectional view taken along Y-Y).

The jig 40 includes a channel 41 having a curved bottom convexed downwardly as viewed in FIG. 5 in conformity with the shape of the upper curved periphery of the seal member 30, and a base 40B (not shown in FIG. 5) covering this channel. It should be noted that while the base 40B is described as covering the jig 40 since FIG. 5 is shown as a perspective view of the jig 40 seen from the bottom side, the jig 40 is actually placed on the base 40B as shown in FIG. 6B.

The base 40B is a flat board of relatively less hard material (such as a board of wood, for example) and the seal member 30-1, 30-2 is held down and fixed by this base 40B and the jig 40 during the cutting.

The jig 40 is provided at one end of the channel 41 with a protrusion 42 extending in a V-shape (the angle being about 60°). If the seal member 30 is cut by depressing down a V-shaped cutting blade 43 along the complementarily shaped walls of this V-shaped protrusion 42 orthogonally to the channel 41 (moving it in the direction of the arrow in FIGS. 5 and 6B) until it comes into abutment with the base 40B, a convex V-shaped cross-section is formed on one side of the seal member while a concave V-shaped cross-section is formed on the other side. The portion of the string-like seal member extending beyond the apex of the V-shaped protrusion 42 may also be prevented from movement during the cutting by any suitable support means. These jig 40, base 40B and V-shaped cutting blade 43 comprise a cutting apparatus.

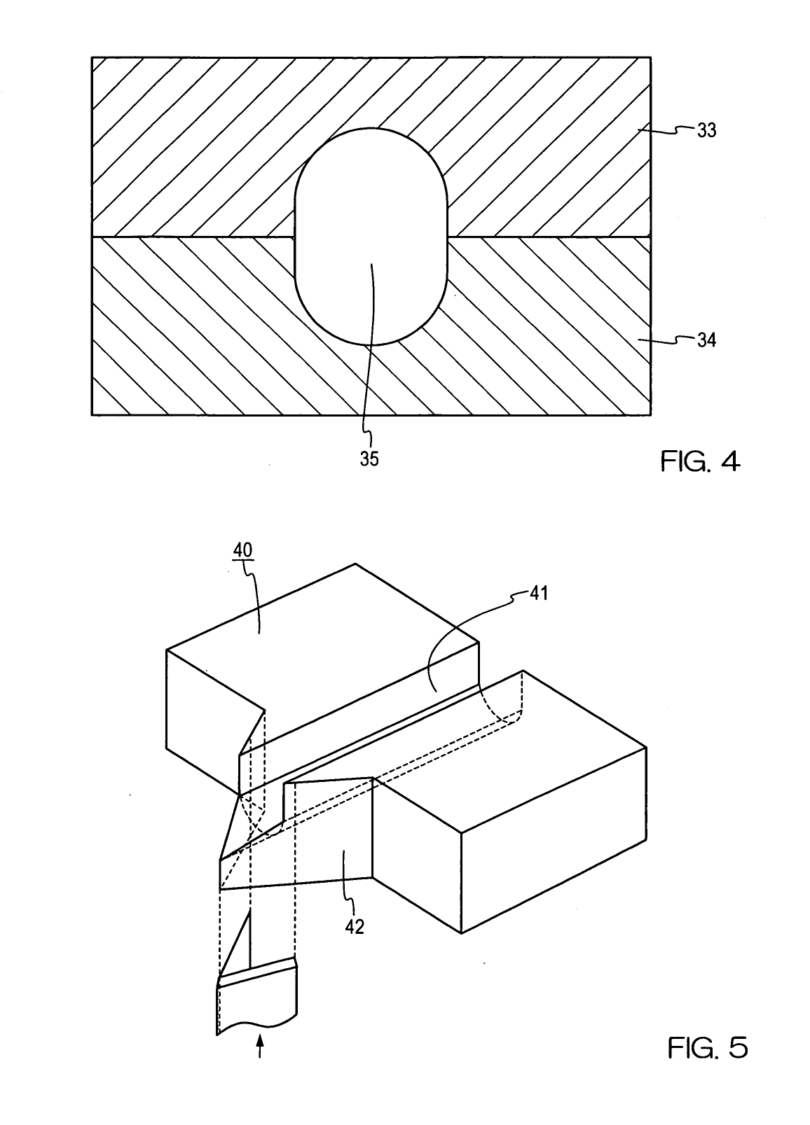

The thus severed string-like seal member strip 30S has a convex V-shaped cut face 30SA on one end thereof and a concave V-shaped cut face 30SB on the other end as shown in FIG. 3A, and these convex and concave V-shaped cut faces are bonded together by the use of a rubber-based adhesive (such as CEMEDINE Company Limited trade names “Super X or “PM100” series, for example) to form a seal ring 39 as shown in FIG. 3B. Consequently, the seal ring of the present invention has no limitation on its across-the ring diameter. Further, it is needless to say that the adhesive mentioned above is only an example and any other suitable one may be used.

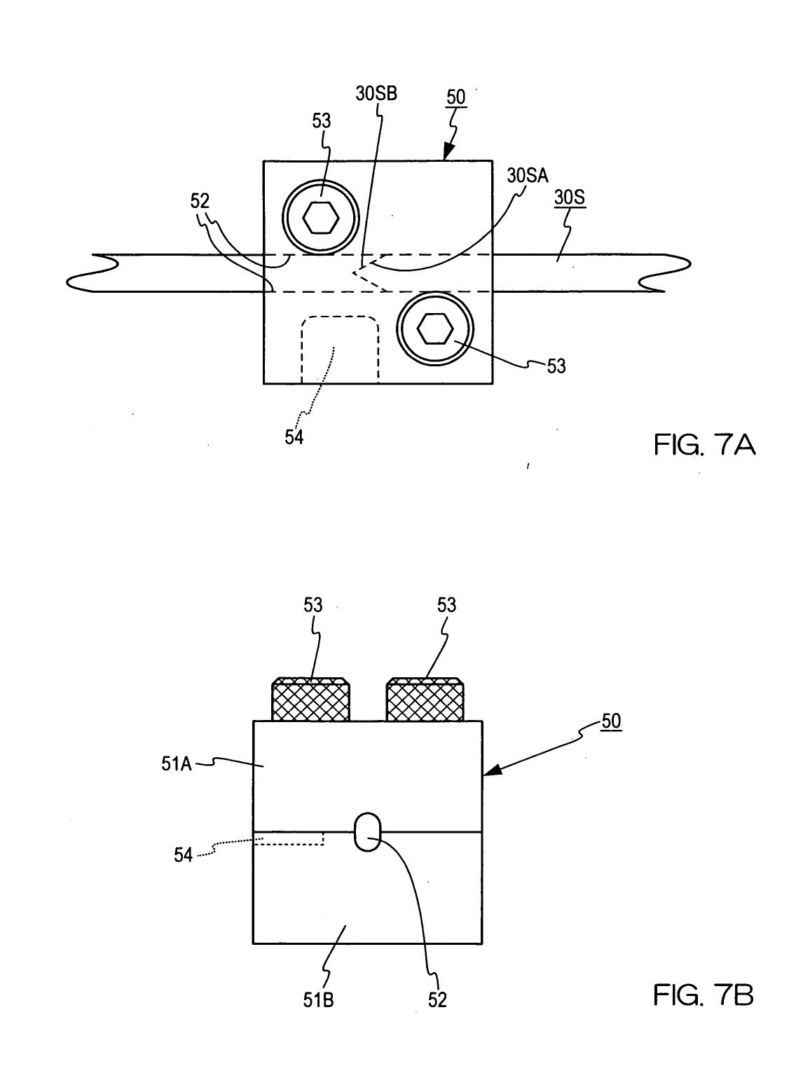

In forming a ring, the attitude of the cross-section of the string-like body of elastic material should be such that its major axis is oriented orthogonally to the radial direction of the ring. That is, the bonding should be done such that its major axis is oriented in the direction of the depth of the recessed groove. FIGS. 7A and 7B shows the construction of a bonding jig 50 used to bond the string-like seal member strip 30S in the form of a ring. The bonding jig 50 is constricted such that two hold-down devices 51A and 51B are vertically separable from each other and that a cavity 52 is defined between the mating faces of the hold-down devices 51A and 51B. The cross-sectional shape of the cavity 52 conforms to the cross-sectional shape of the seal member shown in FIG. 1A or 1B. The portions of the seal member strip 30S to be bonded together are inserted in this cavity 52 and the hold-down devices 51A and 51b are clamped and secured together. In this state, the seal member strip is held until the adhesive is adequately cured. In this regard, the bonding jig 50 is provided with screws 53 for clamping the hold-down devices 51A and 51b together which are fixed in place by tightening the screws 53. In addition, 54 indicates a notch into which the tip of a driver or any other suitable tool is to be inserted. Upon completion of the bonding, the notch 54 is used to separate the hold-down devices 51A and 51b apart by inserting the tip of a driver (not specifically shown) into the notch.

In use, the thus manufactured seal ring for use with leakage testing apparatus is mounted in a seal jig installed on the leakage testing apparatus.

FIG. 9A shows a seal jig 20 having mounted thereon a seal ring 39 for leakage testing apparatus utilizing the seal member 30-1 having a cross-sectional shape according to the first embodiment of fibs invention shown in FIG. 1, and FIG. 9B illustrating how the seal jig is practically used (after the pressure-contact).

In the seal jig 20 for leakage testing apparatus according to this invention, the pressure-contact surface 22 is formed with a recessed groove 23 of square shape in cross-section having a width W and a depth D, and the seal ring 39 is inserted vertically into the recessed groove 23 such that the major axis L_{A} of the cross-section is oriented in the direction of the depth of the recessed groove 23. In this regard, if the depth D of the recessed groove, that is, the inserted amount D of the seal ring is determined, the projecting amount of the seal member will be determined. However, in order to prevent that portion of the seal member projecting out of the recessed groove from collapsing in the course of being compressed before it is pressed into the recessed groove, it is desirable that the value of D be in the order of about 65˜85% of the length of the major axis L_{A}, hence the projecting amount T′ above the pressure-contact surface 22 should be in the order of about 15˜35% of the length of the major axis L_{A}. The more desirable range of the values of D may be in the order of about 65˜80%, hence the projecting amount T′ above the pressure-contact surface 22 may be in the order of about 15˜35% of the length of the major axis L_{A} and more desirably in the order of about 20˜35%.

Further, the groove width W is determined such that the proportion of the cross-sectional area of that portion of the seal member embedded in the recessed groove relative to the cross-sectional area of die recessed groove is about 88˜92%. Usually, the groove width W is made approximately equal to the length L_{B} of the transverse axis. Consequently, the restrainedly inserted state is realized, so that the resistance to the pressure-contacting is kept from being reduced due to the seal member being deformed and expanded width wise in the recessed groove in the process of the pressure-contacting.

The seal jig has stoppers 25 attached thereto, and it is required that the portion of the seal ring projecting beyond the height t of the stoppers (that is the amount of the projecting amount T′ minus t) be compressively deformed to thereby produce an adequate pressure-contacting effect. Taking the conditions into account, the length of the major axis and the depth of the recessed groove are determined (see FIG. 9A).

For the stoppers used in the present invention, resin having a low thermal conductivity (such as acetal resin or polyamide resin or the like, for example) is used, and it should be ensured that the height (thickness) be in the order of 1 mm. In this regard, while it may be possible to make it low (thin) in profile, it is desirable that it be 0.5˜1.0 mm thick, because if it is excessively thin, it may possibly be broken.

The seal jig 20 according to the first embodiment of this invention shown in FIGS. 9A, 9B is using a seal ring of a rectangular shape in cross-section having a minor axis B of 3.5 mm in length L_{B}, a major axis A of 5 mm in length L_{A}, with the edges of the four corners removed in the form of an arc with radius of curvature of L_{A}/3 (corresponding to L_{B}/2), as shown in FIG. 1.

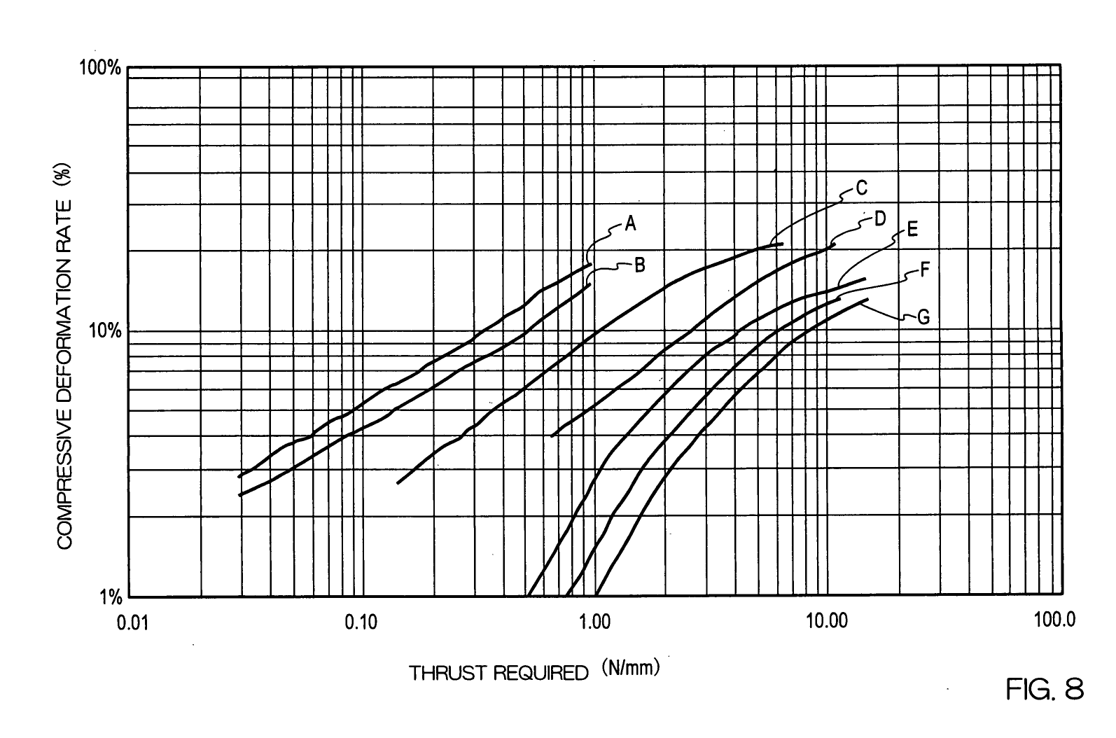

If the relationship between the compressive deformation rate (=projecting amount prior to compression−projecting amount after compression)/height of major axis prior to compression) of this seal ring and the force required to compress it is plotted on a graph, it is as shown in FIG. 8.

In FIG. 8, the curve E, the curve F and the curve G are graphs of the compressive deformation rate versus the thrust required of the seal rings according to the present invention having JISA hardness of 60 degrees, 70 degrees, and 90 degrees, respectively which are embedded tip to 80% of their diameters in their restrainedly inserted state into a recessed groove having a groove width approximately equal to the lengths of their minor axes.

It is also noted that as stated before, in FIG. 8 the data regarding O-rings of 3.5 mm in diameter are shown for comparison for reference purposes, in which the curve A and the curve B are graphs of the compressive deformation rate versus the thrust required of O-rings by themselves (in non-restrainedly inserted state) having JISA hardness of 60 degrees and 70 degrees, respectively. The curve C and the curve D are graphs of the compressive deformation rate versus the thrust required of O-rings having JISA hardness of 60 degrees and 70 degrees, respectively which are embedded up to 80% of their diameters in their restrainedly inserted state into a recessed groove having a groove width approximately equal to the lengths of their minor axes.

Here, considering the curves C and D and the curves E, F and G for comparison, the seal rings of the present invention having a minor axis length equal to its cross-sectional diameter requires greater thrusts as compared to the conventional O-ring to accomplish the same rate of compressive deformation. This mean that the present seal ring requires a less rate of compressive deformation to obtain a thrust necessary to accomplish a desired seal, and requires a less length to be compressed, as compared to the O-ring.

Now, an instance in which a leakage testing apparatus is realized by the use of an oblong seal ring according to the present invention having a JISA hardness of 60 degrees will be described.

Assuming that the thrust required for a seal ring used in this example is 5˜10N/mm, the compressive deformation rate will range from 12 to 16% and the amount of compressive deformation will be about 0.6˜0.8 mm. If the height of the stoppers is 1.0 mm as indicated above, the projecting height thereof above the jig will be 1.8 mm, and hence the depth D of the recessed groove (=the amount of the seal ring inserted into the recessed groove) is set at about 3.2 mm which is the length L_{A} of the major axis minus the projecting height of 1.8 mm.

As to the stoppers, a plurality of stoppers are disposed discretely around the recessed groove 23 as explained with reference to FIGS. 11A, 11B. And while as the material therefor acetal resin, polyamide resin and the like are mentioned from a standpoint of thermal insulating property and shock resistance, it is needless to say that any other suitable materials may be used.

Further, as will also be appreciated from the curves E, F and G in FIG. 8, it is seen that the seal ring of the present invention tends to saturate as the rate of compression exceeds 10%. For this reason, if the projecting height above the recessed groove is set at a height equal to a height corresponding to such 10% compression rate plus a height corresponding to the thickness of the stopper and if the seal thrust is set at around 10N/mm, it may be possible that so much seal noise due to fluctuations in the amount of compressive deformation of the seal member may not be generated even without the stopper.

Consequently, the use of the seal ring of the present invention may realize a leakage testing apparatus which does not bring an article being tested 10 into contact with the seal jig 20 and yet does not allow seal noise to generate, even if the stopper is not necessarily used.

### EFFECTS OF THE INVENTION

The use of the seal ring for leakage testing apparatus of this invention allows for conducting leak test without bringing an article being tested into contact with the seal jig, whereby the occurrence of drift may be suppressed, so that a leakage testing apparatus may be provided which is capable of conducting leak test without making drift compensations. In addition, since occurrence of seal noise is also suppressed during the leakage testing, it is possible to conduct leak test with high sensitivity.

Moreover, since the dimension in the direction of the minor axis is made short, less compressive force is required to obtain a predetermined amount of compressive deformation, providing another advantage of suppressing a cost increase in this respect.

Further, since a uniform seal member may cope with any article being tested, regardless of the size of the opening thereof so that the design may be simple and very economical.

What is claimed is:

1. A string-like seal member for use with a leakage testing apparatus, which is formed of elastic material and has a rounded-corner rectangular shape in cross-section having a major axis, a minor axis extending perpendicularly to the major axis and shorter than the major axis, major sides equal to the length of the major axis, and minor sides equal to the length of the minor axis, with the edges at four corners arcuately removed therefrom to form a rounded-corner rectangular shape.

2. The string-like seal member for use with a leakage testing apparatus set forth in claim 1, wherein said minor sides of the rounded-corner rectangular shape in cross-section are formed in a semi-circular arc with a radius of curvature half the length of the minor axis.

3. The string-like seal member for use with a leakage testing apparatus set forth in claim 1, wherein the length of said major axis of the rounded-corner rectangular shape in cross-section does not exceed two times the length of the minor axis.

4. The string-like seal member for use with a leakage testing apparatus set forth in claim 1, wherein the length of said major axis of the rounded-corner rectangular shape in cross-section is set at 1.2˜1.5 times the length of the minor axis.

5. A seal ring for use with a leakage testing apparatus, which comprises a seal member strip cut from the seal member set forth in any of claims 1 to 4 and having opposite ends thereof bonded together in the form of a ring in an attitude such that said major axis is oriented in the direction in which a compressive force is exerted.

6. A seal jig for use with a leakage testing apparatus, which has a pressure-contact surface for an article being tested, said pressure-contact surface having formed therein a ring-shaped recessed groove in which the seal ring for a leakage testing apparatus set forth in claim 5 is mounted such that its major axis is oriented in the direction of the depth of said recessed groove and that one of said minor sides projects out of said recessed groove, the height of that portion of the seal ring projecting out of said recessed groove being set at a height sufficient that a gap remains between the article being tested and the seal jig when the peripheral portion of the opening of the article being tested is brought into pressure-contact with the projecting portion of the seal ring and compresses the seal ring in such a direction as to force it into the recessed groove until a desired seal thrust is reached.

7. The seal jig for use with a leakage testing apparatus set forth in claim 6, which further has a plurality of stoppers are mounted on said pressure-contact surface, the height of said stoppers being set to be lower than the height of that portion of the seal ring projecting out of said recessed groove, the arrangement being such that the peripheral portion of the opening of the article being tested is brought into pressure-contact with the projecting portion of the seal ring and compressively deforms the seal ring in the direction of said major axis until said peripheral portion comes into abutment with said stoppers.

8. The seal jig for use with a leakage testing apparatus set forth in claim 7, wherein said stoppers are formed of a low thermal conductivity resin.
